(19) United States
(12) Patent Application Publication
(10) Pub. No.: US 2026/0219449 A1
(43) Pub. Date: Jul. 30, 2026

(54) PHOTONIC INTEGRATED CIRCUIT FOR PERFORMING MATRIX-MATRIX MULTIPLICATION

(71) Applicant: Q.ant GmbH, Stuttgart (DE)

(72) Inventors: Andreas Abt, Pfaffenweiler (DE); Alejandro Lorenzo Ruiz, Stuttgart (DE)

(21) Appl. No.: 19/457,966

(22) Filed: Jan. 23, 2026

(30) Foreign Application Priority Data
Jan. 29, 2025 (DE) 102025103244.0

(51) Int. Cl. G02B 6/122; G02B 6/12; G06E 3/00

(52) U.S. Cl. CPC G02B 6/1228; G02B 6/12004; G02B 6/1223; G06E 3/008; G02B 2006/12142; G02B 2006/12147; G02B 2006/12159

(57) ABSTRACT

A photonic integrated circuit for performing matrix-matrix multiplication includes a first layer and a second layer arranged on top of the first layer. A plurality of first waveguides is arranged within the first layer, and a plurality of second waveguides is arranged within the second layer, with the waveguides in each layer configured to avoid crossings in a top view. At least two coupling positions are provided at which at least one first waveguide is optically coupled to at least one second waveguide. The circuit further includes at least four modulators optically coupled by the first waveguides and the second waveguides and configured to perform multiplication and addition of matrix values. The first waveguides are formed from a first material and the second waveguides are formed from a second material different from the first material, thereby enabling efficient interlayer optical coupling and a compact, scalable architecture for photonic matrix-matrix multiplication.

### TECHNICAL FIELD

This disclosure relates to a photonic integrated circuit for performing matrix-matrix multiplication.

### BACKGROUND

Matrix-matrix multiplication is an important application for photonic integrated circuits. For this usually crossbar-array and systolic architectures are used.

The disadvantage of this is that the structures become large and complex. A large amount of crossings between the waveguides is needed. This leads to potential interference problems and thus degrading the quality of signal, difficulty routing and limiting the scalability of the system.

### SUMMARY

Unless otherwise stated, all terms in this specification and the claims have their ordinary and customary meaning as understood by a person of ordinary skill in the art.

As used herein, “optically coupled” means coupled in a manner that permits transmission of an optical signal, directly or indirectly, including through evanescent coupling, vertical coupling, tapered coupling, grating-assisted coupling, or coupling via one or more intermediate optical structures.

As used herein, “configured to avoid crossings” means arranged such that crossings between waveguides are reduced or eliminated as a result of the architectural layout of the photonic integrated circuit, and does not require the complete absence of crossings in all views or operating conditions.

As used herein, a “coupling position” refers to a spatial region of the photonic integrated circuit at which optical coupling occurs between at least one first waveguide and at least one second waveguide, and does not require a discrete or separately formed component.

As used herein, a modulator “configured to perform multiplication and addition of matrix values” refers to a modulator configured to modify at least one property of an optical signal in accordance with a matrix value and to contribute the modified optical signal to a combined optical signal representing a sum of products of matrix values.

This disclosure describes a photonic integrated circuit for performing matrix-matrix multiplications, whereby the above disadvantages are eliminated.

In one aspect of the present disclosure, the photonic integrated circuit comprises a first layer, a second layer, a plurality of first waveguides and a plurality of second waveguides. The second layer is arranged on top of the first layer. The plurality of first waveguides is arranged within the first layer, wherein the plurality of first waveguides is configured to avoid crossings with one another, in particular in a top view. The plurality of second waveguides is arranged within the second layer, wherein the plurality of second waveguides is arranged such that crossings between the second waveguides are avoided, in particular in the top view.

The photonic integrated circuit comprises at least two coupling positions. The at least two coupling positions can be designed as vertical coupling positions. At least one, in particular at each, coupling position at least one first waveguide is coupled to at least one second waveguide. In particular, a coupling position is designed for a transition (an optical signal) from the first layer to the second layer.

The photonic integrated circuit comprises at least four modulators coupled by first waveguides and second waveguides for multiplying and/or adding matrix values of matrices to be multiplied together.

In this context, multiplication of matrix values is performed by modulation of an optical signal within a modulator in accordance with a corresponding matrix coefficient, and addition of matrix values is performed by combining optical signals within a waveguide or coupling structure such that their optical powers or phases contribute to a resulting output signal.

This allows to reduce the complexity of the design and size of the photonic integrated circuit. Crossings can be avoided or at least reduced. Interference problems and degrading of the quality of signal can be avoided or at least reduced. The limitation of scaling can be canceled or at least reduced.

In the present application, “coupling” means optical coupling, i.e. a coupling of an optical signal.

According to an aspect of the photonic integrated circuit there can be at least one crossing between first waveguides and second waveguides, in particular in the top view. This allows a compact and easy design of the photonic integrated circuit.

According to an aspect of the photonic integrated circuit at least one modulator can be designed as a Mach-Zehnder interferometer. In particular, all modulators can be designed as Mach-Zehnder interferometers. This allows the modulators to be implemented with simple means.

According to an aspect of the photonic integrated circuit at least two modulators, in particular all modulators, are arranged within the first layer or within the second layer. This allows the modulators to be implemented with simple means.

According to an aspect of the photonic integrated circuit each modulator can have an input and an output for optical signals. The photonic integrated circuit can have at least one signal input. The signal input can be coupled with inputs of at least two modulators by first waveguides. This allows to couple an optical signal into the modulators with simple means.

According to an aspect of the photonic integrated circuit the photonic integrated circuit can have at least one signal output. The signal output can be coupled with outputs of at least two modulators by second waveguides. Alternatively, or additionally, the signal output can be coupled with outputs of at least two modulators by first waveguides and second waveguides. This allows to output an optical signal from the modulators with simple means.

According to an aspect of the photonic integrated circuit the photonic integrated circuit can comprise nine modulators. The optical signal input can be coupled with inputs of at least three modulators by first waveguides.

This allows a compact and simple design of the photonic integrated circuit for performing matrix-matrix multiplication of 3×3 matrices. With nine modulators, a plurality of multiplication and addition operations can be performed per clock cycle, and in some aspects, 15 operations per clock are possible. It is also possible to multiply bigger matrices than 3×3. For multiplying a 3×3 matrix three clocks are needed, but for multiplying a 4×4 matrix eight clocks are needed.

According to an aspect of the photonic integrated circuit the optical signal output can be coupled with outputs of at least three modulators by second waveguides.

This allows a compact and simple design of the photonic integrated circuit for performing matrix-matrix multiplication of 3×3 matrices.

According to one aspect, first waveguides are formed from a first material and second waveguides are formed from a second material. The first material and the second material are different. This allows a simple and efficient coupling between first and second waveguides.

According to one aspect of the photonic integrated circuit, first material can be lithium niobate. Alternatively, or additionally, the second material can be silicon nitride. Other materials are also conceivable. This allows to implement first and second waveguides with simple means.

According to another aspect of the photonic integrated circuit, at at least one coupling position the first waveguide can have a first coupling section and the second waveguide can have a second coupling section. The first and the second coupling sections can be tapered in opposite directions, in particular towards each other. This allows to implement a coupling between first and second waveguides with simple means.

### BRIEF DESCRIPTION OF THE DRAWINGS

Further features, details and advantages are apparent from the wording of the claims and from the following description of aspects with reference to the drawings. It shows schematically:

FIG. 1. is a photonic integrated circuit for performing matrix-matrix multiplication according to a first aspect;

FIG. 2 shows the photonic integrated circuit according to a second aspect;

FIG. 3 shows the photonic integrated circuit according to a third aspect;

FIG. 4 is a sectional view of a coupling position of the photonic integrated circuit; and

FIG. 5 is a top view of the coupling position according to FIG. 4.

### DETAILED DESCRIPTION

In the following description and in the figures, corresponding components and elements have the same reference signs. For the sake of clarity, not all reference signs are shown in all figures.

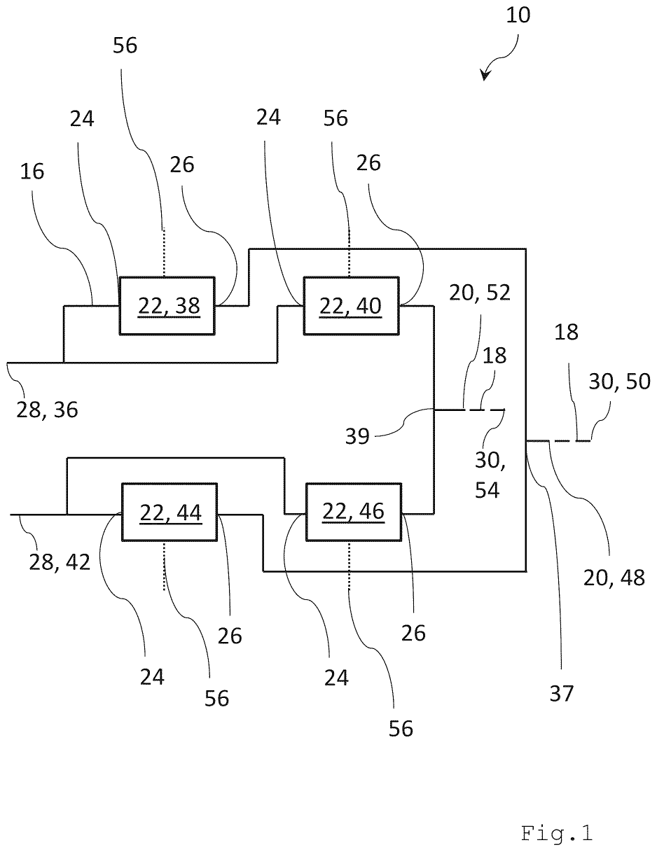

FIG. 1 shows schematically a photonic integrated circuit 10 for performing matrix-matrix multiplication according to a first aspect. FIG. 1 shows a schematic top view.

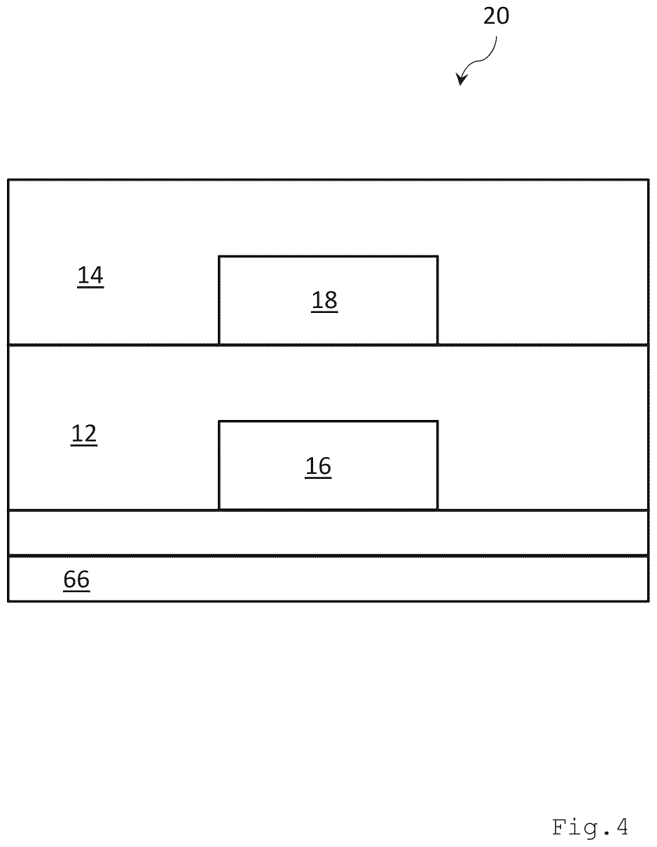

The photonic integrated circuit 10 comprises a first layer 12 and a second layer 14 (see FIG. 4). The second layer 14 is arranged on top of the first layer 12 (as shown in FIG. 4).

The photonic integrated circuit 10 comprises a plurality of first waveguides 16 and a plurality of second waveguides 18. The plurality of first waveguides 16 is arranged within the first layer 12. The plurality of first waveguides 16 is arranged such that crossings between the first waveguides are avoided, in particular in a top view. The plurality of second waveguides 18 is arranged within the second layer 14. There are no crossings between the plurality of second waveguides 18, in particular in the top view.

The plurality of first waveguides 16 and second waveguides 18 can be arranged in two planar levels on top of each other and at a distance from each other. In particular in the sectional view there can be a distance between first waveguides 16 and second waveguides 18.

The photonic integrated circuit 10 comprises at least two coupling positions 20. One first waveguide 16 is coupled to one second waveguide 18 at at least one, in particular at each, coupling positions 20.

The photonic integrated circuit 10 comprises at least four modulators 22 coupled by first waveguides 16 and second waveguides 18 for multiplying and/or adding of matrix values of matrices to be multiplied together.

There can be at least one crossing between first waveguides 16 and second waveguides 18, in particular in the top view.

At least one modulator 22 can be designed as a Mach-Zehnder interferometer. In particular, all modulators can be designed as Mach-Zehnder interferometers.

At least two modulators 22, in particular all modulators 22, can be arranged within the first layer 12 or the second layer 14.

Each modulator 22 can have an input 24 and an output 26 for optical signals. The photonic integrated circuit 10 can have at least one signal input 28. The signal input 28 can be coupled with inputs 24 of at least two modulators 22 by first waveguides 16.

The photonic integrated circuit 10 can have at least one signal output 30. The signal output 30 can be coupled with outputs 26 of at least two modulators 22 by second waveguides 18 or by first and second waveguides 16, 18.

The photonic integrated circuit 10 can have nine modulators 22. The optical signal input 28 can be coupled with inputs 24 of at least three modulators 22 by first waveguides 16. The optical signal output 30 can be coupled with outputs 26 of at least three modulators 22 by second waveguides 18.

In FIGS. 1 to 3, first waveguides 16 are illustrated by solid lines, second waveguides 18 are illustrated by dashed lines and electrical signals are illustrated by dotted lines.

In the aspect of FIG. 1, the photonic integrated circuit 10 has two signal inputs 28, two signal outputs 30, four modulators 22 and two coupling positions 20. A first signal input 36 is coupled with the inputs 24 of a first modulator 38 and a second modulator 40 by first waveguides 16. A second signal input 42 is coupled with the inputs 24 of a third modulator 44 and a fourth modulator 46 by first waveguides 16.

The outputs 26 of the first modulator 38 and the third modulator 44 are coupled together by first waveguides 16 at a first position 37. The first position 37 is coupled by a first waveguide 16 to a second waveguide 18 at a first coupling position 48. The second waveguide 18 couples the first coupling position 48 with a first signal output 50.

The outputs 26 of the second modulator 40 and the fourth modulator 46 are coupled together by first waveguides 16 at a second position 39. The second position 39 is coupled by a first waveguide 16 to a second waveguide 18 at a second coupling position 52. The second waveguide 18 couples the second coupling position 52 with a second signal output 54.

With the aspect of FIG. 1 two cycles are required to multiply two 2×2 matrices together. For performing the following multiplication:

$$( \begin{matrix}A & B \\ C & D\end{matrix} ) \times ( \begin{matrix}K & L \\ M & N\end{matrix} ) = ( \begin{matrix}AK + BM & AL + BN \\ CK + DM & CL + DN\end{matrix} )$$

A is set to the first signal input 36 and B is set to the second signal input 42 in the first cycle. C is set to the first signal input 36 and D is set to the second signal input 42 in the second cycle.

K is set to the first modulator 38 by an electrical signal 56, L is set to the second modulator 40, Mis set to the third modulator 44 and Nis set to the fourth modulator 46.

The outcome at the first signal output 50 is AL+BN for the first cycle and CL+DN for the second cycle. The outcome at the second signal output 54 is AK+BM for the first cycle and CK+DM for the second cycle.

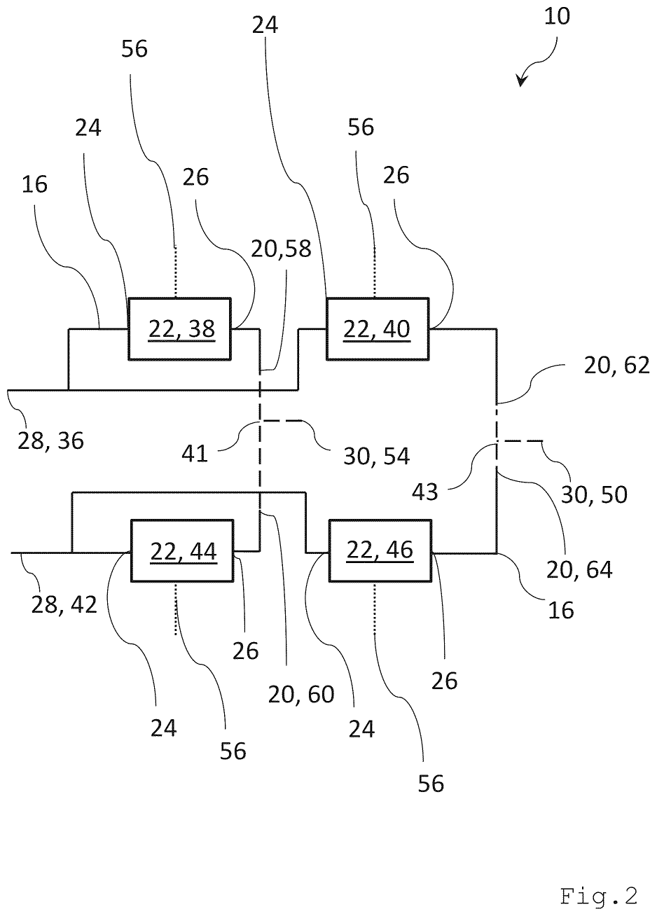

FIG. 2 shows schematically the photonic integrated circuit according to a second aspect. FIG. 2 shows a schematic top view. The second aspect differs from the first aspect by the following:

The photonic integrated circuit 10 has four coupling positions 20. The output 26 of the first modulator 38 is coupled by a first waveguide 16 to a second waveguide 18 at a third coupling position 58. The output 26 of the third modulator 44 is coupled by a first waveguide 16 to a second waveguide 18 at a fourth coupling position 60. The second waveguides 18 that are coupled to first modulator 38 and third modulator 44 by first waveguides 16 are coupled together at a third position 41. The second signal output 54 is coupled to the third position 41 by a second waveguide 18.

The output of the second modulator 40 is coupled by a first waveguide 16 to a second waveguide 18 at a fifth coupling position 62. The output 26 of the fourth modulator 46 is coupled by a first waveguide 16 to a second waveguide 18 at a sixth coupling position 64. The second waveguides 18 that are coupled to the second modulator 40 and fourth modulator 46 by first waveguides 16 are coupled together at a fourth position 43. The first signal output 50 is coupled to the fourth position 43 by a second waveguide 18.

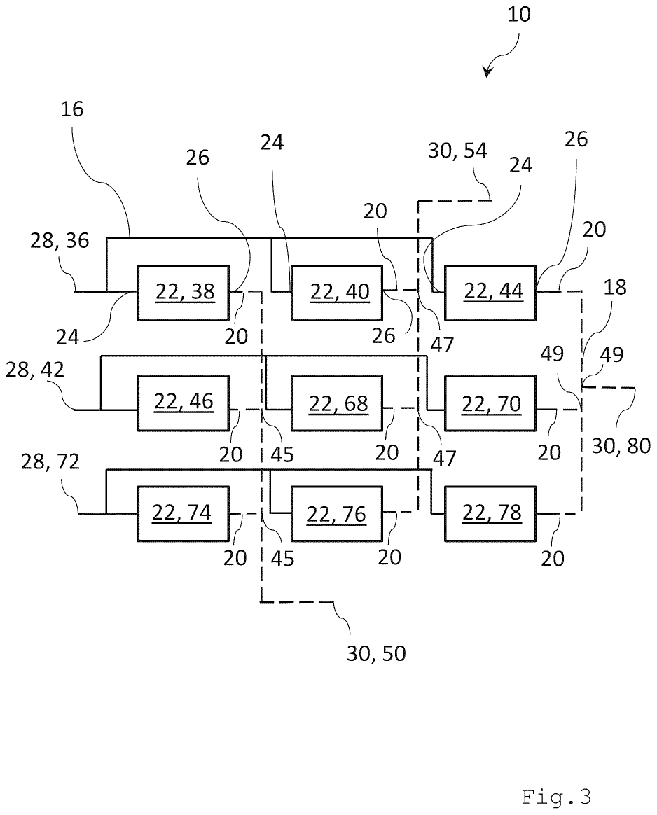

FIG. 3 shows schematically the photonic integrated circuit according to a third aspect. FIG. 3 shows a schematic top view. The third aspect differs from the first aspect by the following:

The photonic integrated circuit 10 has three signal inputs 28, three signal outputs 30, nine modulators 22 and nine coupling positions 20.

The first signal input 36 is coupled to the inputs 24 of the first modulator 38, the second modulator 40 and the third modulator 44. The second signal input 42 is coupled to the inputs 24 of the fourth modulator 46, a fifth modulator 68 and a sixth modulator 70. A third signal input 72 is coupled to the inputs 24 of a seventh modulator 74, an eighth modulator 76 and a ninth modulator 78. Each signal input 36, 42, 72 is coupled to the inputs 24 of the respective modulators 38, 40, 44, 46, 68, 70, 74, 76, 78 by first waveguides 16. The outputs 26 of the nine modulators 38, 40, 44, 46, 68, 70, 74, 76, 78 are each coupled by a first waveguide 16 to a second waveguide 18 at the nine coupling positions 20.

The second waveguides 18 that are coupled with the outputs 26 of the first modulator 38, the fourth modulator 46 and the seventh modulator 74 are coupled together at two fifth positions 45 and are coupled to the first signal output 50.

The second waveguides 18 are coupled with the outputs 26 of the second modulator 40, the fifth modulator 68 and the eighth modulator 76 are coupled together at two sixth positions 47 and are coupled to the second signal output 54.

The second waveguides 18 are coupled with the outputs 26 of the third modulator 44, the sixth modulator 70 and the ninth modulator 78 are coupled together at two seventh positions 49 and are coupled to a third signal output 80.

With the aspect of FIG. 3 the multiplication of two 3×3 matrices is possible:

$$A \times B$$

$$with$$

$$A = ( {a}_{11} {a}_{12} {a}_{13} {a}_{21} {a}_{22} {a}_{23} {a}_{31} {a}_{32} {a}_{33} )$$

$$and$$

$$B = ( {b}_{11} {b}_{12} {b}_{13} {b}_{21} {b}_{22} {b}_{23} {b}_{31} {b}_{32} {b}_{33} )$$

The matrix values of A are set to three signal inputs 28 within three cycles. In the first cycle, a₁₁, a₁₂, a₁₃ are set to the three signal inputs, a₁₁ is set to the first signal input 28, @12 is set to the second signal input 28 and a₁₃ is set to the third signal input 28 in the first cycle.

The matrix values of B are set to the modulators 22 by electrical signals, a corresponding bₓₓ for each modulator 22. The first cycle produce:

$${a}_{11} {b}_{12} + {a}_{12} {b}_{22} + {a}_{13} {b}_{32}$$

at a first signal output 30

$${a}_{11} {b}_{13} + {a}_{12} {b}_{23} + {a}_{13} {b}_{33}$$

at a second signal output 30 and

$${a}_{11} {b}_{1} + {a}_{12} {b}_{21} + {a}_{13} {b}_{31}$$

at a third signal output 30. The second and the third cycles can be executed accordingly.

FIG. 4 shows schematically a sectional view of a coupling position 20 of the photonic integrated circuit 10.

The first layer 12 can be made from silicon dioxide (SiO₂). The first layer can be arranged on a silicon substrate 66. The second layer 14 can be arranged on top (above) the first layer 12. The second layer 14 can be made from silicon dioxide (SiO₂).

The first waveguides 16 and the second waveguides 18 can be spaced apart from one another and/or above each other. The first waveguides 16 can be formed from a first material. The second waveguides 18 can be formed from a second material. The first material and the second material can be different materials.

The first material can be lithium niobate. The second material can be silicon nitride. Other materials are also possible.

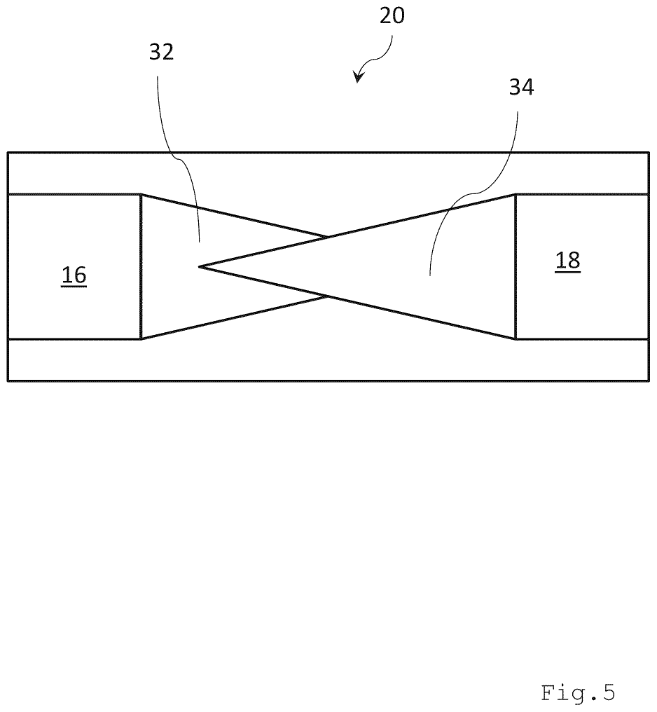

FIG. 5 shows schematically a top view of the coupling position 20 of the photonic integrated circuit 10 according to FIG. 4.

At the coupling position 20, the first waveguide 16 can have a first coupling section 32 and the second waveguide 18 can have a second coupling section 34. The first and the second coupling sections 32, 34 can be tapered in opposite directions, in particular towards each other.

To the extent not already described, the different features and structures of the various aspects can be used in combination, or in substitution with each other as desired. That one feature is not illustrated in all of the aspects is not meant to be construed that it cannot be so illustrated, but is done for brevity of description. Thus, the various features of the different aspects can be mixed and matched as desired to form new aspects, whether or not the new aspects are expressly described. All combinations or permutations of features described herein are covered by this disclosure.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the present disclosure is not limited to the precise aspects described, and that various other changes and modifications can be effected by one skilled in the art without departing from the scope or spirit of the disclosure.

Additionally, the elements and features shown or described in connection with certain aspects can be combined with the elements and features of certain other aspects without departing from the scope of the present disclosure, and that such modifications and variations are also included within the scope of the present disclosure. Accordingly, the subject matter of the present disclosure is not limited by what has been particularly shown and described.

What is claimed:

1. A photonic integrated circuit for performing matrix-matrix multiplication, comprising:
a first layer;
a second layer arranged on top of the first layer;
a plurality of first waveguides arranged within the first layer, the plurality of first waveguides being configured to avoid crossings with one another in a top view;
a plurality of second waveguides arranged within the second layer, the plurality of second waveguides being configured to avoid crossings with one another in a top view;
at least two coupling positions at which at least one first waveguide is optically coupled to at least one second waveguide; and
at least four modulators optically coupled by the first waveguides and the second waveguides and configured to perform multiplication and addition of matrix values,
wherein the first waveguides are formed from a first material and the second waveguides are formed from a second material different from the first material.

2. The photonic integrated circuit of claim 1, wherein at least one crossing is present between a first waveguide and a second waveguide in a top view.

3. The photonic integrated circuit of claim 1, wherein at least one of the modulators is a Mach-Zehnder interferometer.

4. The photonic integrated circuit of claim 3, wherein each of the modulators is a Mach-Zehnder interferometer.

5. The photonic integrated circuit of claim 1, wherein at least two of the modulators are arranged within the first layer or within the second layer.

6. The photonic integrated circuit of claim 1, wherein each modulator has an optical input and an optical output, and wherein the photonic integrated circuit comprises at least one signal input optically coupled to optical inputs of at least two modulators by first waveguides.

7. The photonic integrated circuit of claim 6, further comprising at least one signal output optically coupled to optical outputs of at least two modulators by at least one of the second waveguides or a combination of the first waveguides and the second waveguides.

8. The photonic integrated circuit of claim 7, wherein the photonic integrated circuit comprises nine modulators, and wherein the signal input is optically coupled to optical inputs of at least three modulators by first waveguides.

9. The photonic integrated circuit of claim 8, wherein the signal output is optically coupled to optical outputs of at least three modulators by second waveguides.

10. The photonic integrated circuit of claim 1, wherein the first material comprises lithium niobate and the second material comprises silicon nitride.

11. The photonic integrated circuit of claim 1, wherein at at least one coupling position the first waveguide comprises a first coupling section and the second waveguide comprises a second coupling section, and wherein the first coupling section and the second coupling section are tapered in opposite directions.
